(19) United States
(12) Patent Application Publication
(10) Pub. No.: US 2015/0052278 A1
(43) Pub. Date: Feb. 19, 2015

(54) Dock Apparatus of Mobile Electronic Device and Connecting Method Thereof

(71) Applicant: Much-ip Co. Ltd., Zhubei (TW)

(72) Inventors: Shao-Hung Lo, Zhubei (TW); Ming-Chou Lee, Zhubei (TW)

(73) Assignee: Much-ip Co. Ltd., Zhubei (TW)

(21) Appl. No.: 14/228,111

(22) Filed: Mar. 27, 2014

(30) Foreign Application Priority Data
Aug. 13, 2013 (TW) 102128996

(51) Int. Cl. G06F 13/40

(52) U.S. Cl. CPC G06F 13/4068; G06F 13/4027
USPC 710/303

(57) ABSTRACT

The present invention discloses a dock apparatus for connecting a mobile electronic device. The dock apparatus includes the following modules. A connection port module is configured for physically connecting to the mobile electronic device. A control module is configured for retrieve a first parameter and a display data of the mobile electronic device via the connection port module. A wireless communication module coupled to the control module is configured for establishing a wireless connection to the mobile electronic device according to the first parameter. A wired communication module is configured for connecting to the wireless communication module and an external network and for bridging the wireless communication module and the external network. A power module is configured to supply electric power to the mobile electronic device. A heat dissipation module is configured to transfer heat away from the mobile electronic device.

### CROSS REFERENCE TO RELATED PATENT APPLICATIONS

This application claims priority to Taiwanese Patent Application No. 102128996, filed on Aug. 13, 2013, entitled “Extension Device and Connecting Method Thereof,” which is hereby incorporated by reference in its entirety.

### FIELD OF THE INVENTION

The present invention relates to a dock apparatus and a connecting method of the dock apparatus, and more particularly relates to a dock apparatus for connecting to a mobile electronic device and the method of connecting the mobile electronic device and the dock apparatus.

### BACKGROUND OF THE INVENTION

Mobile electronic devices, such as mobile phones, PDAs, tablet PCs and laptops, bring people many convenient services and have been a part of modern life.

Generally, due to the carrying convenience, the size and the weight of mobile electronic devices are limited, and the size of input device and the quality or size of the display are limited as well. For this reason, the dock apparatus having bigger input device, better display quality, and faster and more stable internet connection has been popular on the market. In combination with mobile electronic device, the memory contents, the multi-media function and the data processing ability of the mobile electronic device can still be utilized.

One the other hand, the dock apparatus usually uses a designated interface to connect with mobile electronic device. In addition to the designated electrical-machine interface, a specific upper-layer transmission protocol must be installed in both dock apparatus and mobile electronic device for communication.

Therefore, a dock apparatus which can provide expanded functions to variety kinds of mobile electronic devices through the industry-standard interface is needed.

### SUMMARY OF THE INVENTION

A dock apparatus for connecting a mobile electronic device is disclosed in an embodiment of the present invention. The dock apparatus includes a connection port module, control module, a wireless communication module, and a wired communication module. The connection port module is configured for physically connecting to the mobile electronic device. The control module is configured for retrieving a first parameter and a display data of the mobile electronic device via the connection port module. The wireless communication module is connected to the control module and is configured for establishing a wireless connection to the mobile electronic device according to the first parameter. The wired communication module is connected to the wireless communication module and an external network and is configured for bridging the wireless communication module and the external network.

A connecting method of a dock apparatus for connecting to a mobile electronic device is disclosed in another embodiment of the present invention. The connecting method includes: physically connecting to the mobile electronic device via a connection port module of the dock apparatus; retrieving a first parameter and a display data of the mobile electronic device; transferring the display data to a display device; establishing a wireless connection between the mobile electronic device and the wireless communication module of the dock apparatus according to the first parameter; and bridging the wireless communication module via the wired communication module to an external network.

According to the above, the present invention discloses a dock apparatus and a connecting method for connecting to a mobile electronic device. The dock apparatus physically connects to the mobile electronic device to retrieve a first parameter, so as to establish a wireless connection between the dock apparatus and the mobile electronic device. Then the dock apparatus connects to an external network via the wired communication module.

### BRIEF DESCRIPTION OF THE DRAWINGS

FIG. 1 is a block diagram of an extended electronic system applying the dock apparatus according to one embodiment of the present invention;

FIG. 2 is a flowchart of a connecting method of a dock apparatus according to one embodiment of the invention.

### DETAILED DESCRIPTION OF THE PREFERRED EMBODIMENT

Some embodiments of the present invention are described as follows. Besides the disclosed embodiments, the present invention could be widely implemented in other embodiments. The embodiment shall not limit the scope of the present invention defined in the claims. For providing clearer descriptions to the persons skilled in the art so they can understand the content of the present invention, the parts in the figures are not drawn in the correct relative size and proportion. Some parts will be significantly enlarged in scale with unrelated parts omitted.

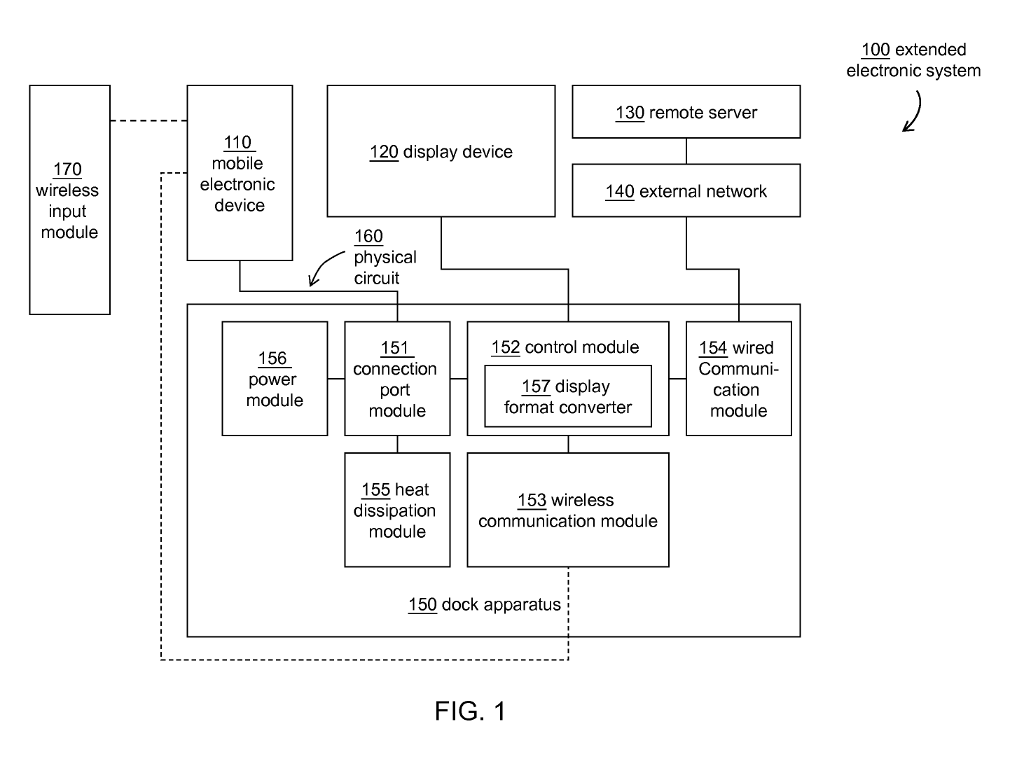

Referring to FIG. 1, a block diagram of an extended electronic system according to one embodiment of the present invention. The extended electronic system 100 includes, but not limited to, the following modules: a mobile electronic device 110, a display device 120, a remote server 130, an external network 140, a dock apparatus 150, and a wireless input module 170. The dock apparatus 150 includes, but not limited to, the following modules: a connection port module 151, a control module 152, a wireless communication module 153, and a wired communication module 154. In the present embodiment, the dock apparatus 150 further includes a heat dissipation module 155 and a power module 156. Each module of the dock apparatus 150 is contained in a housing (not shown in the figure).

The examples of the mobile electronic device 110 include, but not limited to, the mobile phones, the PDAs, the tablet PCs and the laptops. The mobile electronic device 110 connects to the dock apparatus 150 via a physical circuit 160, especially the aforementioned connection port module 151. In one embodiment, the aforementioned physical circuit 160 may be the common industrial interfaces such as the USB (Universal Serial Bus), the IEEE 1394 interface or the Thunderbolt interface. In another embodiment, the aforementioned physical circuit 160 also may be a particular interface having a higher market share, such as the 30-pin interface, the 5-pin interface or the Lightning interface from Apple, the 30-pin or the 11-pin interface from Samsung, and the common 4-pin Micro USB, etc. In one embodiment, the physical circuit 160 could carry the display data compliant with the Mobile High-Definition Link (MHL). The connection port module 151 may include one or more connection port of the physical circuit 160, for connecting to other electronic devices in addition to the mobile electronic device 110.

In one embodiment, the display device 120 is connected to the dock apparatus 150. However the display device 120 is not limited to be configured inside or outside the dock apparatus 150. The major usage of the display device 120 is to display a display data outputted by the mobile electronic device 110. In one embodiment, the dock apparatus 150 uses the display format compliant with the High Definition Multimedia Interface (HDMI), and outputs the display data to the display device 120 for displaying.

The remote server 130 is connected to the wired communication module 154 of the dock apparatus 150 via the external network 140. The mobile electronic device 110 is communicatively linked to the dock apparatus 150 through a wireless connection established by the wireless communication module 153. In other words, the wireless communication module 153 of the present embodiment is configured to establish the wireless connection with the mobile electronic device 110. The wired communication module 154 of the present embodiment is configured for bridging the wireless communication module 153 and the external network 140. The control commands and other signals of the mobile electronic device 110 received by the wireless communication module 153 via the wireless connection, are transferred to the remote server 130 via the wired connection. The wireless communication module 153 could support one or more wireless communication protocols at the same time, such as the IEEE 802.11 Wireless Local Area Network (WLAN), the Bluetooth and the Wireless USB. Similarly, the wired communication module 154 could also support one or more wired communication protocols at the same time, such as the IEEE 802.3 Ethernet. The external network 140 could be, for example, the local area network or the internet.

In one embodiment, for avoiding other electronic devices being interfered by the wireless communication module 153, the transmitting power or the transmitting frequency of the wireless communication module 153 could be controlled to limit the wireless coverage. In another embodiment, a shielding material layer may be added in or on the housing, at least covering the portion of the dock apparatus 140 corresponding to the wireless communication module 153, for reducing the wireless coverage of the wireless communication module 153.

In one embodiment, the heat dissipation module 155 contacts with the connection port module 151 through at least one metal wire for transferring heat away from the connection port module 151 and the connected mobile electronic device 110. The metal wire contacts with at least one ground pin of the connection port module 151, and the ground pin may contact to at least one ground pin of the physical circuit 160, so that the heat of the mobile electronic device 110 can be transferred via at least one ground pin of the physical circuit 160, to at least one ground pin of the connection port module, and finally to the heat dissipation module 155 to be dissipated.

In one embodiment, the power module 156 is connected to the connection port module 151 for supplying electric power to the mobile electronic device 110 via the physical circuit 160. When the connection port module 151 is connected to other electronic devices, the power module 156 may also supply electric power to them. When the connection port module 151 is simultaneously connected to the mobile electronic device 110 and other electronic devices, the power module 156 could simultaneously supply electric power to the mobile electronic device 110 and other electronic devices.

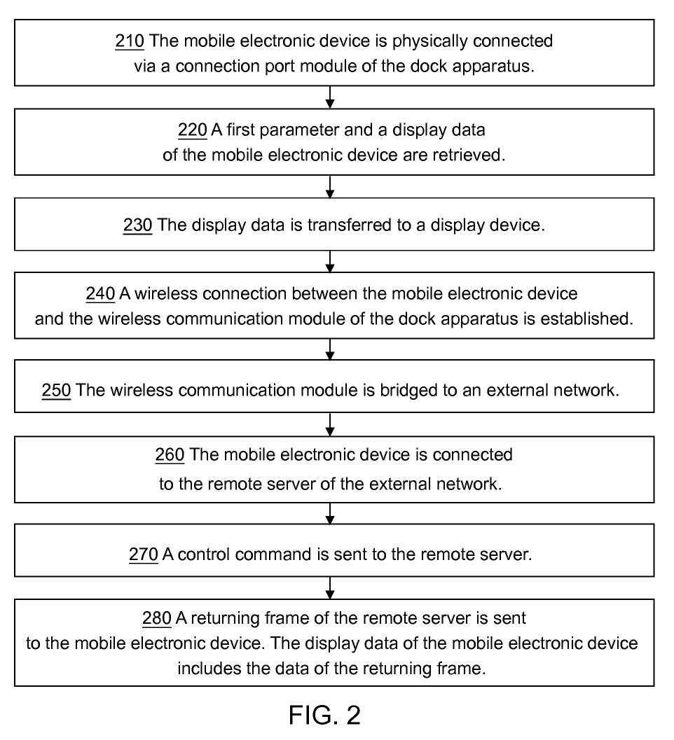

Referring to FIG. 2, which is a flowchart of a connecting method of a dock apparatus according to one embodiment of the present invention. Here, the dock apparatus 150 shown in the FIG. 1 is implemented in the connecting method. For the convenience of explanation, the connecting method could refer to the embodiment shown in the FIG. 1 at the same time. However, the person skilled in the art should understand that dock apparatus other than the one shown in FIG. 1 can also be implemented in the connecting method. The steps included in the connecting method can be performed in any order, not limited in the below description. The person skilled in the art should understand, except for the essential order relations, the execution order of each step is not limited in the present invention.

Step 210, the step of physically connecting to the mobile electronic device 110 via a connection port module 151 of the dock apparatus 150 is shown. The mobile electronic device 110 and the connection port module 151 could be physically connected via the physical circuit 160.

Step 220, the step of retrieving a first parameter and a display data of the mobile electronic device 110 is shown. After physical connecting of the mobile electronic device 110, the necessary protocol exchange can be proceeded by the dock apparatus 150 and the mobile electronic device 110 to commence connection in the physical layer. The details are known by the person skilled in the art and are not described here. Then, the control module 152 retrieves a first parameter and a display data of the mobile electronic device 110 via the connection port module 151. Wherein the first parameter is used to establish a wireless connection with the mobile electronic device 110 via the wireless communication module 153, and the display data is transferred to the display device 120 to be displayed. In one embodiment, the wireless communication module 153 complies with IEEE 802.11 specifications, and the first parameter at least includes the Media Access Control (MAC) address which complies with IEEE 802.11 specifications.

Step 230, the step transferring the display data to a display device 120 is shown. When the display data is retrieved by the control module 152, the display data is transferred to the display device 120. In one embodiment, the display data is in a first display format, and the display data to be inputted into the display device 120 is in a second display format. That is to say, before the display data is transferred to the display device, it has been converted from the first display format to the second display format. The control module 152 of the present embodiment could further include a display format converter 157 which is configured for converting the display data from the first display format into the second display format. In one example of the embodiment, the first display format at least includes the Mobile High-Definition Link (MHL), and the second display format at least includes the High Definition Multimedia Interface (HDMI).

Step 240, the step of establishing a wireless connection between the mobile electronic device 110 and the wireless communication module 153 of the dock apparatus 150 according to the first parameter is shown. In one embodiment, the wireless communication module 153 complies with IEEE 802.11 specifications, and the first parameter at least includes the Media Access Control (MAC) address which complies with IEEE 802.11 specifications. In other words, the wireless connection is established according to the MAC address of the mobile electronic device 110. In one embodiment, if the MAC address of the mobile electronic device 110 is not in the permit list of the dock apparatus 150, the wireless connection will not be established between the dock apparatus 150 and the mobile electronic device 110. In another embodiment, if the MAC address of the mobile electronic device 110 is in the forbidden list of the dock apparatus 150, the wireless connection also will not be established between the dock apparatus 150 and the mobile electronic device 110. The person skilled in the art should understand the first parameter required for different types of wireless connection may be different, and they are not described here in more detail.

Step 250, the step of bridging the wireless communication module 153 to an external network 140 is shown. After wireless connection is established between the dock apparatus 150 and the mobile electronic device 110, the dock apparatus 150, act as a bridge, can be configured for bridging the communication between the mobile electronic device 110 and the external network 140. In one embodiment, the dock apparatus 150 connects to the external network 140 via the wired communication module 154. By this way, the wired communication module 154 is configured for bridging the wireless communication module 153 and the external network 140, to transform the wireless connection between the wireless communication module 153 and the mobile electronic device 110 into the wired connection so as to connect and communicate with the external network 140.

In one embodiment, in order to have the computing capacity of the remote server 130 utilized by the user through the mobile electronic device 110, the connecting method in FIG. 2 further includes the optional steps 260-280. These steps 260-280 can be proceeded only after completing the steps 210-250.

Step 260, the step of connecting the mobile electronic device 110 to the remote server 130 of the external network 140 is shown. In one embodiment, the connection here may be refer to the connection to the upper-layer application, such as the Remote Desktop Connection Manager from Microsoft, the famous cross-platform RNC programs, the X-Window or other applications.

Step 270, the step of sending a control command to the remote server 130 is shown. The control command is originated from the mobile electronic device 110. After the connection to the upper-layer application is built, the dock apparatus 150 could transfer the control command to the remote server 130. After the control command is received by the remote server 130, some high performance computing or mass computing can be carried out, such as the 3D simulation, the video frame editing, or the parallel computing.

Step 280, the step of sending a returning frame of the remote server 130 to the mobile electronic device 110 is shown. The display data of the mobile electronic device 110 includes the data of the returning frame. When the remote server 130 responses to the control command, a returning frame would be sent back to the mobile electronic device 110. Then, the mobile electronic device 110 sends the display data including the returning frame to the dock apparatus 150 via the connection port module 151, for subsequently displaying the returning frame on the display device 120. The person skilled in the art should understand the so-called “returning frame” may not merely present the data of the frame itself; the example of the returning frame includes the HTML/XML data of web pages, or the expression data of the above-mentioned applications.

In addition to the steps 210-280 shown in the FIG. 2, in another embodiment, the connecting method further includes a step of heat dissipating. Heat is transferred away from the connection port module 151 and the connected mobile electronic device 110. In one example of the embodiment, heat being transferred to a heat dissipation module 155 of the dock apparatus 150 via a ground pin of the connection port module 151.

In one embodiment, the display device 120 can be used as an output device for the mobile electronic device 110. Moreover, a wireless input module 170 can be used as an input device for the mobile electronic device 110. The wireless input module 170 can be input devices such as the wireless keyboard, the mouse, the light pen, the touch pen, the touch panel, etc. In the above embodiment of the connecting method, a second parameter of the wireless input module 170 can be transferred to the mobile electronic device 110. Then, the communication can be built between the wireless input module 170 and mobile electronic device 110, and the communication is built based on the second parameter. For example, the second parameter is the Bluetooth identification code of the wireless input module 170 while the mobile electronic device 110 and the wireless input module 170 communicate via Bluetooth. The second parameter can be pre-store in the control module 152 of the dock apparatus 150 and to be provided to the mobile electronic device 110 during connecting process. In this manner, the mobile electronic device 110 can skip the time consuming pairing process with the wireless input module 170.

According to the above-mentioned embodiments, the present invention discloses a dock apparatus and a connecting method of the dock apparatus for connecting to a mobile electronic device. The dock apparatus is physically connected to the mobile electronic device to retrieve a first parameter to establish a wireless connection between the dock apparatus and the mobile electronic device, and then connects to an external network via a bridged wired communication.

The above-mentioned present the preferred embodiments of the present invention are not intended to limit the scope of the claims. As such, all modification and substitutions of the invention are considered falling within the spirit, scope and intent of the disclosure as defined by the following claims.

1. A dock apparatus for connecting a mobile electronic device comprising:
a connection port module configured for physically connecting to the mobile electronic device;
a control module configured for retrieving a first parameter and a display data of the mobile electronic device via the connection port module;
a wireless communication module connecting to the control module and configured for establishing a wireless connection to the mobile electronic device according to the first parameter; and
a wired communication module connecting to the wireless communication module and an external network and configured for bridging the wireless communication module and the external network.

2. The dock apparatus according to claim 1, further comprising:
a shielding material layer at least covering the portion of the dock apparatus corresponding to the wireless communication module for reducing the wireless coverage of the wireless communication module.

3. The dock apparatus according to claim 1, further comprising:
a heat dissipation module contacting to the connection port module with a metal wire for transferring heat away from the connection port module and the connected mobile electronic device.

4. The dock apparatus according to claim 3, wherein the connection port module comprises a ground pin, and the metal wire contacts with the ground pin.

5. The dock apparatus according to claim 1, further comprising:
a power module connecting to the connection port module for supplying electric power to the mobile electronic device and/or other electronic devices.

6. The dock apparatus according to claim 1, wherein the control module stores a second parameter of a wireless input module, and the control module is further configured for transferring the second parameter to the mobile electronic device so that the mobile electronic device communicates with the wireless input module according to the second parameter.

7. The dock apparatus according to claim 1, wherein the display data of the mobile electronic device is in a first display format, and the control module comprises:
a display format converter which is configured for converting the first display format of the display data into a second display format.

8. The dock apparatus according to claim 7, wherein the first display format at least comprises the Mobile High-Definition Link (MHL), and the second display format at least comprises the High Definition Multimedia Interface (HDMI).

9. The dock apparatus according to claim 1, wherein the wireless communication module complies with IEEE 802.11 specifications, and the first parameter at least comprises the Media Access Control (MAC) address which complies with IEEE 802.11 specifications.

10. The dock apparatus according to claim 1, wherein the mobile electronic device connects to the remote server of the external network via the wireless connection and the wired communication module, for sending a control command to the remote server.

11. The dock apparatus according to claim 10, wherein the remote server carries out an operation according to the control command, and sends a returning frame to the mobile electronic device via the wired communication module and the wireless connection, and wherein the display data of the mobile electronic device comprises the data of the returning frame.

12. A connecting method of a dock apparatus, for connecting to a mobile electronic device, and the connecting method comprising:
physically connecting to the mobile electronic device via a connection port module of the dock apparatus;
retrieving a first parameter and a display data of the mobile electronic device;
transferring the display data to a display device;
establishing a wireless connection between the mobile electronic device and the wireless communication module of the dock apparatus according to the first parameter; and
bridging the wireless communication module to an external network.

13. The connecting method according to claim 12, further comprising:
transferring heat away from the connection port module and the connected mobile electronic device.

14. The connecting method according to claim 13, wherein heat is transferred to a heat dissipation module of the dock apparatus via a ground pin of the connection port module.

15. The connecting method according to claim 12, further comprising:
transferring a second parameter of a wireless input module to the mobile electronic device; and
establishing a connection between the wireless input module and the mobile electronic device according to the second parameter.

16. The connecting method according to claim 12, before transferring the display data to the display device, further comprising:
converting a first display format of the display data to a second display format.

17. The connecting method according to claim 12, further comprising:
connecting the mobile electronic device to a remote server of the external network;
sending a control command to the remote server, the control command is originated from the mobile electronic device; and
receiving a returning frame from the remote server, wherein the display data of the mobile electronic device comprises the data of the returning frame.
